(19) United States
(12) Patent Application Publication
(10) Pub. No.: US 2026/0167054 A1
(43) Pub. Date: Jun. 18, 2026

(54) BATTERY ENERGY ALLOCATION SYSTEM AND BATTERY ENERGY ALLOCATION METHOD FOR ELECTRIC VEHICLE

(71) Applicants: HYUNDAI MOTOR COMPANY, Seoul (KR); Kia Corporation, Seoul (KR)

(72) Inventors: Jian Xiong ZHAO, Shandong (CN); Xinyu CUI, Shandong (CN)

(73) Assignees: HYUNDAI MOTOR COMPANY, Seoul (KR); Kia Corporation, Seoul (KR)

(21) Appl. No.: 19/415,708

(22) Filed: Dec. 10, 2025

(30) Foreign Application Priority Data
Dec. 16, 2024 (CN) 202411854065.2

(51) Int. Cl. B60L 58/12; B60H 1/00; B60L 1/02; G01C 21/36

(52) U.S. Cl. CPC B60L 58/12; B60H 1/00392; B60H 1/00771; B60L 1/02; G01C 21/3679; B60L 2250/00; B60L 2260/20

(57) ABSTRACT

A battery energy allocation system and a battery energy allocation method for an electric vehicle are disclosed. The system includes an input device receiving driver input, including at least driver input to charge a vehicle battery during vehicle traveling and driver input indicating no charging during travel, and a controller configured to sequentially allocate battery energy to a vehicle traveling demand and an HVAC demand, based on the priority of the vehicle traveling demand being higher than the priority of the HVAC demand, in response to the input device receiving the driver input indicating no charging during travel, and to synchronously allocate battery energy to the vehicle traveling demand and the HVAC demand in response to the input device receiving the driver input to charge the vehicle battery during vehicle traveling.

### CROSS-REFERENCE TO RELATED APPLICATION(S)

This application claims priority to and the benefit of Chinese Patent Application No. 202411854065.2 filed at the Chinese National Intellectual Property Administration on Dec. 16, 2024, the entire contents of which are incorporated herein by reference in their entireties.

### TECHNICAL FIELD

The present disclosure relates to the field of vehicle technology, and more particularly, to a battery energy allocation system and a battery energy allocation method for an electric vehicle.

### BACKGROUND

Electric vehicles (EVs) encompass several types, including battery electric vehicles (BEVs), which rely solely on energy stored in a battery to power an electric motor; fuel cell electric vehicles (FCEVs), which generate electricity from hydrogen fuel cells; and hybrid electric vehicles (HEVs), which combine an internal combustion engine with an electric motor. Regardless of type, most EVs depend on high-voltage battery packs that repeatedly charge and discharge during operation to supply power not only to the traction motor but also to auxiliary systems such as heating, ventilation, and air conditioning (HVAC).

While EV adoption continues to grow, significant challenges remain. One critical issue is the accuracy of distance-to-empty (DTE) predictions, which estimate how far the vehicle can travel before the battery is depleted. Drivers often experience anxiety when traveling through unfamiliar areas or regions with limited charging infrastructure, especially under complex and variable driving conditions. Current EV systems attempt to learn dynamically from past driving behavior, but they lack the ability to predict future conditions, making range estimation unreliable in many scenarios. As a result, drivers cannot always determine with confidence whether they will reach their destination.

Another complication arises from competing energy demands. Battery power must be allocated not only for propulsion but also for comfort systems like HVAC. Excessive energy consumption by HVAC can significantly reduce the vehicle's all-electric range (AER), potentially leaving drivers stranded. Conversely, when drivers prioritize range over comfort and avoid using HVAC in extreme temperatures, the driving experience suffers.

Thus, there is an urgent need for a smart battery energy allocation system-one that can dynamically and intelligently distribute energy between propulsion and auxiliary loads.

### SUMMARY

Embodiments of the present disclosure attempt to provide a battery energy allocation system and a battery energy allocation method for an electric vehicle capable of reasonably allocating battery energy to secure sufficient energy required for vehicle traveling and maximize the use of a heating, ventilation and air conditioning (HVAC) system.

According to an embodiment of the present disclosure, a battery energy allocation system for an electric vehicle is provided.

The system includes an input device receiving driver input, including at least driver input to charge a vehicle battery during vehicle traveling and driver input not to charge the vehicle battery during the vehicle traveling, and a controller configured to: sequentially allocate battery energy to a vehicle traveling demand and a heating, ventilation and air conditioning (HVAC) demand, based on priority of the vehicle traveling demand being higher than priority of the HVAC demand, in response to the input device receiving the driver input not to charge the vehicle battery during the vehicle traveling, and synchronously allocate the battery energy to the vehicle traveling demand and the HVAC demand in response to the input device receiving the driver input to charge the vehicle battery during the vehicle traveling.

The controller may be further configured to: determine whether the vehicle traveling demand is satisfied based on synchronously allocating the battery energy to the vehicle traveling demand and the HVAC demand; and sequentially allocate the battery energy to the vehicle traveling demand and the HVAC demand according to the priority of the vehicle traveling demand being higher than the priority of the HVAC demand, based on determining that the vehicle traveling demand is not satisfied.

The driver input may include driver input regarding vehicle traveling route setting, and the controller may be configured to: generate a traveling route based on the driver input regarding the vehicle traveling route setting received by the input device when allocating the battery energy to the vehicle traveling demand; and obtain road information on the traveling route, including at least a portion of a road type included in the traveling route, a length of each road type, a unit road energy consumption corresponding to each road type, traveling speed and traveling time of the vehicle, and a road gradient based on the generated traveling route.

The controller may be configured to: calculate battery energy required for the vehicle to travel to a target location by the following equation, based on the obtained road information on the traveling route, and set the calculated battery energy required for the vehicle to travel to the target location as the vehicle traveling demand when sequentially allocating the battery energy to the vehicle traveling demand and the HVAC demand:

$$W = ( {L}_{city} \times F . E {.}_{city} + {L}_{national} \times F . E {.}_{national} + {L}_{highway} \times F . E {.}_{highway} ) \times r$$

wherein W is the battery energy required for the vehicle to travel to the target location, L_{city} is a length of an urban road during the vehicle traveling, F.E._{city} is a unit road energy consumption of the urban road, Lₙₐₜᵢₒₙₐₗ is a length of a national road during the vehicle traveling, F.E.ₙₐₜᵢₒₙₐₗ is a unit road energy consumption of the national road, L_{highway} is a length of the highway during the vehicle traveling, F.E._{highway} is a unit road energy consumption of the highway, and r is a correction factor calculated according to a road gradient during the vehicle traveling. A destination may be set as the target location based on the input device receiving the driver input not to charge the vehicle battery during the vehicle traveling, and a charging station may be set as the target location based on the input device receiving the driver input to charge the vehicle battery during the vehicle traveling.

Alternatively, the controller may be configured to calculate battery energy required for the vehicle to travel to the target location by the following equation, based on the obtained road information on the traveling route, and set the calculated battery energy required for the vehicle to travel to the target location as the vehicle traveling demand when sequentially allocating the battery energy to the vehicle traveling demand and the HVAC demand:

$$W = {\int }_{0}^{{t}_{city}} {P}_{city} dt + {\int }_{0}^{{t}_{national}} {P}_{national} dt + {\int }_{0}^{{t}_{highway}} {P}_{highway} dt$$

wherein W is the battery energy required for the vehicle to travel to the target location, t_{city} is a traveling time of the vehicle on the city road, tₙₐₜᵢₒₙₐₗ is a traveling time of the vehicle on the national road, t_{highway} is a traveling time of the vehicle on the highway, Pₙₐₜᵢₒₙₐₗ is power that wheels must output at each time when the vehicle is traveling on the national road, P_{highway} is power that the wheels must output at each time when the vehicle is traveling on the highway, and P_{city} is power that the wheels must output at each time when the vehicle is traveling on the city road. The destination may be set as the target location based on the input device receiving the driver input not to charge the vehicle battery during the vehicle traveling, and the charging station may be set as the target location based on the input device receiving the driver input to charge the vehicle battery during the vehicle traveling.

The controller may be configured to calculate available battery energy of an HVAC system by the following equation and set the calculated available battery energy of the HVAC system as the HVAC demand when sequentially allocating the battery energy to the vehicle traveling demand and the HVAC demand:

$${W}_{r} = {W}_{a} - W$$

wherein Wᵣ is the available battery energy of the HVAC system, Wₐ is the available battery energy, and W is the battery energy required for the vehicle to travel to the target location. The controller is further configured to control operation of the HVAC system according to the calculated available battery energy of the HVAC system, wherein the controller is configured to calculate maximum available power of the HVAC system by the following equation:

$${P}_{HVAC} = \frac{{W}_{r}}{T}$$

wherein P_{HVAC} is the maximum available power of the HVAC system, Wᵣ is the available battery energy of the HVAC system, and T is a traveling time for the vehicle to reach the target location. After calculating the maximum available power of the HVAC system, the operating power of the HVAC system may be controlled to be less than or equal to the maximum available power of the HVAC system.

The controller may be configured to compare the maximum available power of the HVAC system with an upper limit of the operating power of an operating mode of the HVAC system when controlling the operating power of the HVAC system to be less than or equal to the maximum available power of the HVAC system, and determine an operating mode in which the upper limit of the operating power is less than or equal to the maximum available power of the HVAC system as a selectable operating mode and provide the operating mode to a driver.

The driver input may include driver input for setting the operating power of the HVAC system. When synchronously allocating the battery energy to the vehicle traveling demand and the HVAC demand, an accumulated battery energy required for the vehicle may be calculated by the following equation based on the obtained road information on the traveling route, and the accumulated battery energy required for the vehicle may be set as a sum of the vehicle traveling demand and the HVAC demand:

$${W}_{total} = {\int }_{0}^{t} ( {P}_{s} + P ) dt$$

wherein Wₜₒₜₐₗ is the accumulated battery energy required for the vehicle, Pₛ is the operating power of the HVAC system set by the driver, P is the power that the wheels must output at each time when the vehicle is traveling. When determining whether the vehicle traveling demand is satisfied, the traveling speed of the vehicle may be obtained, and the traveling speed of the vehicle may be accumulated to obtain the traveling distance of the vehicle corresponding to a time, the accumulated battery energy required for the vehicle may be compared with the available battery energy, the time when the accumulated battery energy required for the vehicle is equal to the available battery energy may be determined, and the traveling distance of the vehicle corresponding to the determined time may be determined as a maximum traveling distance, a charging station along the traveling route and the traveling distance to the charging station may be obtained, the traveling distance to the charging station may be compared with the maximum traveling distance, based on the traveling distance to the charging station being less than or equal to the maximum traveling distance, the corresponding charging station may be determined as a charging station that the vehicle is reachable, and it may be determined that the vehicle traveling demand is satisfied based on an existence of the charging station that the vehicle is reachable, and it may be determined that the vehicle driving demand is not satisfied based on an absence of the charging station that the vehicle is reachable.

The following equation may be used to calculate the power that the wheels must output at each time:

$$P = [ {f}_{0} + {f}_{1} \times ( \frac{{V}_{i} + {V}_{i - 1}}{2} ) + {f}_{2} \times {( \frac{{V}_{i} + {V}_{i - 1}}{2} )}^{2} + ( 1.03 \times TM ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀, f₁, and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is a time difference between time (i) and time (i−1), TM is the vehicle's mass, g is an acceleration of gravity, and a is the road gradient.

Alternatively, the following equation may be used to calculate the power that the wheels must output at each time:

$$P = [ {f}_{0} \times cos a + {f}_{2} \times {( \frac{{V}_{i} + {V}_{i - 1}}{2} )}^{2} + ( 1.03 \times TM ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀ and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

Alternatively, the following equation may be used to calculate the power that the wheels must output at each time:

$$P = [ TM \times f \times cos a + \frac{{C}_{D} \times A}{21.25} \times {( \frac{{V}_{i} + {V}_{i - 1}}{2} )}^{2} + TM \times g \times sin a + ( 1.03 \times TM ) \times ( \frac{{V}_{i} - {V}_{i - 1}}{Δ t} ) ] \times \frac{{V}_{i}}{3.6}$$

wherein P is the power that the wheels must output at time (i), f is a rolling resistance coefficient, which has different values depending on the road type, C_{D} is a wind resistance coefficient, A is a frontal area, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

The battery energy allocation system of the electric vehicle may further include an output device, wherein the controller is configured to control the output device to output at least one of the battery energy required for the vehicle to travel to the target location, the available battery energy of the HVAC system, available time of the HVAC system, and distance till empty (DTE), and the available time of the HVAC system and the DTE are calculated by the following equation:

$${T}_{a} = \frac{{W}_{r}}{{P}_{L}}$$

Here, Tₐ is the available time of the HVAC system, Wᵣ is the available battery energy of the HVAC system, P_{L} is a limited power of the HVAC system, which is the maximum available power of the HVAC system or the upper limit of the operating power in the selected operating mode:

$$DTE = ( {{W}_{a}}^{′} - {{W}_{r}}^{′} ) \times \frac{{L}_{total}}{W}$$

wherein DTE is the distance till empty, Wₐ′ is the available battery energy after the vehicle has travelled for a specific period of time, Wᵣ′ is the available energy of the HVAC system after the specific period of time, which is the difference between the available battery energy (Wᵣ) of the HVAC system and the used battery energy of the HVAC system within the specific period of time, Lₜₒₜₐₗ is the traveling distance to the target location, and W is the battery energy required for the vehicle to travel to the target location.

According to another embodiment of the present disclosure, a battery energy allocation method for an electric vehicle may be provided.

The method may include: receiving driver input, including at least driver input to charge a vehicle battery during vehicle traveling and driver input not to charge the vehicle battery during the vehicle traveling; sequentially allocating battery energy to a vehicle traveling demand and an HVAC demand, based on priority of the vehicle traveling demand being higher than priority of the HVAC demand, in response to receiving the driver input not to charge the vehicle battery during the vehicle traveling; and synchronously allocating the battery energy to the vehicle traveling demand and the HVAC demand in response to receiving the driver input to charge the vehicle battery during the vehicle traveling.

The synchronously allocating the battery energy to the vehicle traveling demand and the HVAC demand may further include: determining whether the vehicle traveling demand is satisfied; and sequentially allocating the battery energy to the vehicle traveling demand and the HVAC demand according to the priority of the vehicle traveling demand being higher than the priority of the HVAC demand, based on determining that the vehicle traveling demand is not satisfied.

The driver input may include driver input regarding vehicle traveling route setting. The allocating the battery energy to the vehicle traveling demand may include: generating a traveling route based on the driver input regarding the vehicle traveling route setting; and obtaining road information on the traveling route, including at least a portion of a road types included in the traveling route, a length of each road type, a unit road energy consumption corresponding to each road type, traveling speed and traveling time of the vehicle, and a road gradient based on the generated traveling route.

The sequentially allocating the battery energy to the vehicle traveling demand and the HVAC demand may include: calculating the battery energy required for the vehicle to travel to a target location by the following equation based on the obtained road information on the traveling route, and setting the calculated battery energy required for the vehicle to travel to the target location as the vehicle traveling demand:

$$W = ( {L}_{city} \times F . E {.}_{city} + {L}_{national} \times F . E {.}_{national} + {L}_{highway} \times F . E {.}_{highway} ) \times r$$

wherein W is the battery energy required for the vehicle to travel to the target location, L_{city} is a length of an urban road during the vehicle traveling, F.E._{city} is a unit road energy consumption of the urban road, Lₙₐₜᵢₒₙₐₗ is a length of a national road during the vehicle traveling, F.E.ₙₐₜᵢₒₙₐₗ is a unit road energy consumption of the national road, L_{highway} is a length of the highway during the vehicle traveling, F.E._{highway} is a unit road energy consumption of the highway, and r is a correction factor calculated according to a road gradient during the vehicle traveling. A destination may be set as the target location based on the input device receiving the driver input not to charge the vehicle battery during the vehicle traveling, and a charging station may be set as the target location based on the input device receiving the driver input to charge the vehicle battery during the vehicle traveling.

Alternatively, the sequentially allocating the battery energy to the vehicle traveling demand and the HVAC demand may include calculating battery energy required for the vehicle to travel to the target location by the following equation based on the obtained road information on the traveling route, and setting the calculated battery energy required for the vehicle to travel to the target location as the vehicle traveling demand:

$$W = {\int }_{0}^{{t}_{city}} {P}_{city} dt + {\int }_{0}^{{t}_{national}} {P}_{national} dt + {\int }_{0}^{{t}_{highway}} {P}_{highway} dt$$

wherein W is the battery energy required for the vehicle to travel to the target location, t_{city} is a traveling time of the vehicle on the city road, tₙₐₜᵢₒₙₐₗ is a traveling time of the vehicle on the national road, t_{highway} is a traveling time of the vehicle on the highway, Pₙₐₜᵢₒₙₐₗ is power that wheels must output at each time when the vehicle is traveling on the national road, P_{highway} is power that the wheels must output at each time when the vehicle is traveling on the highway, and P_{city} is power that the wheels must output at each time when the vehicle is traveling on the city road. The destination may be set as the target location based on the input device receiving the driver input not to charge the vehicle battery during the vehicle traveling, and the charging station may be set as the target location based on the input device receiving the driver input to charge the vehicle battery during the vehicle traveling.

The sequentially allocating the battery energy to the vehicle traveling demand and the HVAC demand may include calculating available battery energy of an HVAC system by the following equation and setting the calculated available battery energy of the HVAC system as the HVAC demand:

$${W}_{r} = {W}_{a} - W$$

wherein Wᵣ is the available battery energy of the HVAC system, Wₐ is the available battery energy, and W is the battery energy required for the vehicle to travel to the target location.

The method may further include controlling the operation of the HVAC system based on the calculated available battery energy of the HVAC system. The controlling operation of the HVAC system based on the calculated available battery energy of the HVAC system may include: calculating maximum available power of the HVAC system by the following equation:

$${P}_{HVAC} = \frac{{W}_{r}}{T}$$

wherein P_{HVAC} is the maximum available power of the HVAC system, Wᵣ is the available battery energy of the HVAC system, and T is a traveling time for the vehicle to reach the target location; and controlling the operating power of the HVAC system to be less than or equal to the maximum available power of the HVAC system, after calculating the maximum available power of the HVAC system.

The controlling the operating power of the HVAC system to be less than or equal to the maximum available power of the HVAC system may include: comparing the maximum available power of the HVAC system with an upper limit of the operating power of an operating mode of the HVAC system, and determining an operating mode in which the upper limit of the operating power is less than or equal to the maximum available power of the HVAC system as a selectable operating mode and providing the operating mode to a driver.

The driver input may include driver input for setting the operating power of the HVAC system. The synchronously allocating the battery energy to the vehicle traveling demand and the HVAC demand may further include: calculating an accumulated battery energy required for the vehicle by the following equation based on the obtained road information on the traveling route, and setting the accumulated battery energy required for the vehicle as a sum of the vehicle traveling demand and the HVAC demand:

$${W}_{total} = {\int }_{0}^{t} ( {P}_{s} + P ) dt$$

wherein Wₜₒₜₐₗ is the accumulated battery energy required for the vehicle, Pₛ is the operating power of the HVAC system set by the driver, P is the power that the wheels must output at each time when the vehicle is traveling. The determining whether the vehicle traveling demand is satisfied may include: accumulating the traveling speed of the vehicle to obtain the traveling distance of the vehicle corresponding to a time; comparing the accumulated battery energy required for the vehicle with the available battery energy; determining the time when the accumulated battery energy required for the vehicle is equal to the available battery energy; determining the traveling distance of the vehicle corresponding to the determined time as a maximum traveling distance; obtaining a charging station along the traveling route to obtain the traveling distance to the charging station; comparing the traveling distance to the charging station with the maximum traveling distance; determining the corresponding charging station as a charging station that the vehicle is reachable, based on the traveling distance to the charging station being less than or equal to the maximum traveling distance; determining that the vehicle traveling demand is satisfied based on an existence of the charging station that the vehicle is reachable; and determining that the vehicle traveling demand is not satisfied based on an absence of the charging station that the vehicle is reachable.

The following equation may be used to calculate the power that the wheels must output at each time:

$$P = [ {f}_{0} + {f}_{1} \times ( \frac{{V}_{i} + {V}_{i - 1}}{2} ) + {f}_{2} \times {( \frac{{V}_{i} + {V}_{i - 1}}{2} )}^{2} + ( 1.03 \times TM ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀, f₁, and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is a time difference between time (i) and time (i−1), TM is the vehicle's mass, g is an acceleration of gravity, and a is the road gradient.

Alternatively, the following equation may be used to calculate the power that the wheels must output at each time:

$$P = [ {f}_{0} \times cos a + {f}_{2} \times {( \frac{{V}_{i} + {V}_{i - 1}}{2} )}^{2} + ( 1.03 \times TM ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀ and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

Alternatively, the following equation may be used to calculate the power that the wheels must output at each time:

$$P = [ TM \times f \times cos a + \frac{{C}_{D} \times A}{21.25} \times {( \frac{{V}_{i} + {V}_{i - 1}}{2} )}^{2} + TM \times g \times sin a + ( 1.03 \times TM ) \times ( \frac{{V}_{i} - {V}_{i - 1}}{Δ t} ) ] \times \frac{{V}_{i}}{3.6}$$

wherein P is the power that the wheels must output at time (i), f is a rolling resistance coefficient, which has different values depending on the road type, C_{D} is a wind resistance coefficient, A is a frontal area, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

The sequentially allocating the battery energy to the vehicle traveling demand and the HVAC demand may further include outputting at least one of the battery energy required for the vehicle to travel to the target location, the available battery energy of the HVAC system, available time of the HVAC system, and the DTE, and the available time of the HVAC system and the DTE are calculated by the following equation:

$${T}_{a} = \frac{{W}_{r}}{{P}_{L}}$$

Here, Tₐ is the available time of the HVAC system, Wᵣ is the available battery energy of the HVAC system, and P_{L} is a limited power of the HVAC system, which is the maximum available power of the HVAC system or the upper limit of the operating power in the selected operating mode:

$$DTE = ( {{W}_{a}}^{′} - {{W}_{r}}^{′} ) \times \frac{{L}_{total}}{W}$$

wherein DTE is the distance till empty, Wₐ′ is the available battery energy after the vehicle has travelled for a specific period of time, Wᵣ′ is the available energy of the HVAC system after the specific period of time, which is the difference between the available battery energy (Wᵣ) of the HVAC system and the used battery energy of the HVAC system within the specific period of time, Lₜₒₜₐₗ is the traveling distance to the target location, and W is the battery energy required for the vehicle to travel to the target location.

According to embodiments of the present disclosure, by rationally allocating battery energy, it is possible to secure sufficient energy required for vehicle traveling, maximizing the HVAC system, thereby improving the driver's driving experience.

In addition, according to embodiments of the present disclosure, it is possible to accurately calculate the battery energy required for driving and at the same time to accurately predict the calculated DTE.

Further, according to embodiments of the present disclosure, by displaying information to the driver such as the battery energy required for the vehicle to travel to the target location, the available battery energy of the HVAC system, available time of the HVAC system, and the DTE, the driver's concern about lack of battery energy while driving may be reduced.

In addition, any advantages which may be obtained or inferred from the embodiments of the present disclosure are directly or implicitly disclosed in the detailed description of the embodiment of the present disclosure.

That is, various advantages inferred from the embodiments of the present disclosure are disclosed in the detailed description that follows.

### BRIEF DESCRIPTION OF THE DRAWINGS

Hereinafter, embodiments of the present disclosure are described in more detail with reference to the accompanying drawings.

For clarity of description, identical parts in different drawings are indicated using the same reference numerals.

It should be noted that the drawings are illustrative only and are not necessarily drawn to scale.

FIG. 1 is a block diagram of a battery energy allocation system for an electric vehicle according to an embodiment of the present disclosure.

FIG. 2 is a flowchart of the operation of a controller according to an embodiment of the present disclosure.

FIG. 3 is a flowchart of the operation of a controller that controls the operation of an HVAC system according to an embodiment of the present disclosure.

FIG. 4 schematically illustrates curves showing changes over time in a traveling speed V of the vehicle, operating power of the HVAC system Pₛ set by the driver, power that the wheels must output at each time P, and total power that the vehicle must output Pₜₒₜₐₗ.

FIG. 5 schematically illustrates curves showing changes over time in an accumulated battery energy required for a vehicle Wₜₒₜₐₗ, the traveling speed V of the vehicle V, and the traveling distance L.

FIG. 6 schematically illustrates the generated traveling route and charging stations located on the traveling route.

FIG. 7 is a flowchart of a battery energy allocation method of an electric vehicle according to an embodiment of the present disclosure.

### DETAILED DESCRIPTION

The present disclosure will be described more fully hereinafter with reference to the accompanying drawings, in which embodiments of the disclosure are shown.

As those skilled in the art would realize, the described embodiments may be modified in various different ways, all without departing from the spirit or scope of the present disclosure.

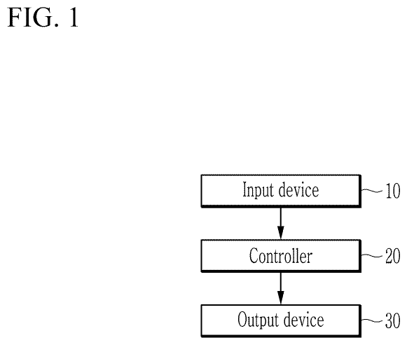

FIG. 1 is a block diagram of a battery energy allocation system for an electric vehicle according to an embodiment of the present disclosure.

As shown in FIG. 1, a battery energy allocation system for an electric vehicle according to an embodiment of the present disclosure includes an input device 10, a controller 20, and an output device 30.

The input device 10 is configured to receive driver input.

The driver input includes at least driver input to charge a vehicle battery during vehicle traveling and driver input indicating no charging during travel.

In response to the input device 10 receiving the driver input indicating no charging during travel, the controller 20 is configured to sequentially allocate battery energy to a vehicle traveling demand and an HVAC demand, based on the priority of the vehicle traveling demand being higher than the priority of the HVAC demand.

In response to the input device 10 receiving the driver input to charge the vehicle battery during vehicle traveling, the controller 20 is configured to synchronously allocate battery energy to the vehicle traveling demand and the HVAC demand.

When synchronously allocating battery energy to the vehicle traveling demand and the HVAC demand, the controller 20 is configured to determine whether the vehicle traveling demand may be satisfied, and sequentially allocate battery energy to the vehicle traveling demand and the HVAC demand according to the priority of the vehicle traveling demand being higher than the priority of the HVAC demand, based on a determination that the vehicle traveling demand cannot be satisfied.

Additionally, the controller 20 may be configured to control the output device 30 to output information related to battery energy allocation.

Hereinafter, the battery energy allocation system according to an embodiment of the present disclosure will be described in detail.

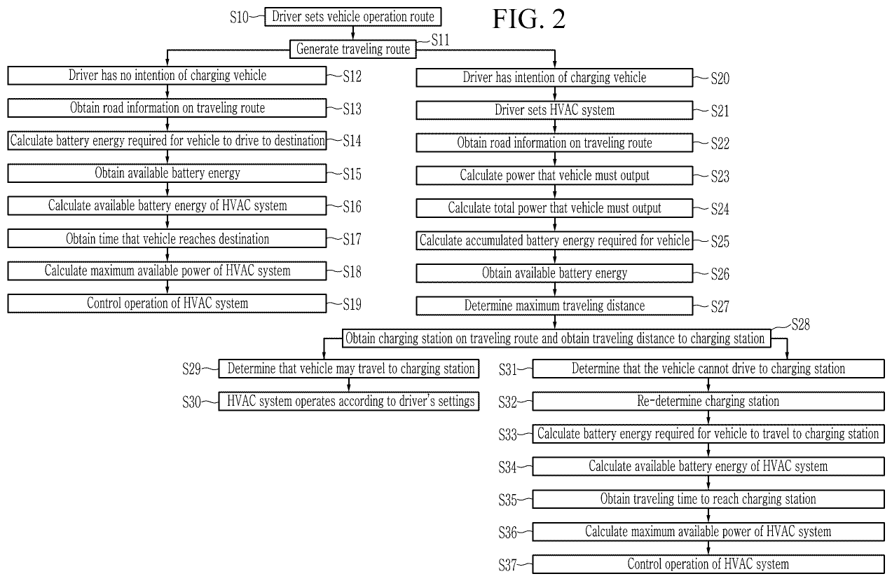

FIG. 2 is a flowchart of the operation of a controller according to an embodiment of the present disclosure.

The input device 10 may receive driver input related to multiple functions and/or operations of the vehicle, and obtain the driver's intention to operate the vehicle through the driver input.

The input device 10 may include an ON/OFF button, a selection button, a physical button (e.g., a button for executing multiple functions), and/or a touch panel.

For example, the input device 10 may be a touch screen provided integrally with a display of an audio video navigation telematics (AVNT) system.

According to an embodiment of the present disclosure, the driver input may include driver input regarding vehicle traveling route setting, driver input for setting the operating power of a heating ventilation and air conditioning (HVAC) system, driver input to charge the vehicle battery during vehicle traveling, and driver input indicating no charging during travel.

Specifically, the driver input regarding vehicle traveling route setting may be driver input for setting a destination, driver input for setting a departure point and a destination, or driver input for selecting a traveling route among the vehicle's traveling routes.

The controller 20 may generate a traveling route (S11) based on the driver input regarding vehicle traveling route setting received by the input device 10 (S10).

In this case, the controller 20 may be realized as part of the AVNT system.

When the input device 10 receives the driver input indicating no charging during travel, the controller 20 determines that the driver has no intention of charging the vehicle during this journey (S12).

Therefore, the priority of vehicle traveling demand should be higher than that of HVAC demand, and battery energy should be preferentially allocated to vehicle traveling so that the vehicle may arrive its destination, and the remaining battery energy may be allocated to the HVAC system.

Accordingly, in response to the input device 10 receiving the driver input indicating no charging during travel, the controller 20 may obtain road information on the traveling route based on the generated traveling route (S13) and calculate the vehicle traveling demand based on the road information on the traveling route (S14).

Here, vehicle traveling demand refers to the battery energy required for the vehicle to travel to the destination.

Specifically, in an embodiment, the road information on the traveling route includes the road types included in the traveling route, the length of each road type, the unit road energy consumption corresponding to each road type, and the road gradient.

Here, road types may include urban roads, highways, and national roads.

The controller 20 may obtain the road types included in the traveling route, the length of each road type, and the road gradient based on big data.

In addition, the controller 20 may obtain unit road energy consumption corresponding to each road type through learning based on big data, and the unit may be kWh/100 km.

For example, driver energy consumption may be recorded on various road types, and once sufficient driver data is secured on various road types, unit road energy consumption on various road types may be determined through statistical analysis and learning based on big data.

As the simplest example, the unit road energy consumption of a road type may be estimated by averaging the energy consumption of multiple passes over the same type of flat road.

The unit road energy consumption of urban roads is less than that of national roads, and the unit road energy consumption of national roads is less than that of highways.

By multiplying the length of each road type by the unit road energy consumption of the corresponding road type and accumulating the results, the battery energy required for the vehicle to drive to the target location (in this case, the destination) may be calculated initially.

However, the road gradient on the traveling road may also affect the battery energy required for the vehicle to travel to the destination.

Electric vehicles typically conserve electricity on flat roads and downhill slopes, and may even charge on downhill slopes.

In contrast, electric vehicles consume electricity when going uphill, and the steeper the gradient, the more battery energy the vehicle consumes.

Accordingly, the controller 20 may calculate a correction factor according to the road gradient and apply the correction factor to the initially calculated result.

The correspondence between the road gradient and the correction factor may be calculated based on the test calibration data of a test engineer during a vehicle test step and is preset in the controller 20.

For example, if the road gradient is consistently less than 5%, the correction factor may be 1, if the road gradient consistently exceeds 5%, the correction factor may be 1.25, and if the road gradient is consistently less than −15%, the correction factor may be −0.8.

In summary, in the above embodiment, the battery energy required for the vehicle to travel to the destination may be calculated by applying the following equation:

$$W = ( {L}_{city} \times F . E {.}_{city} + {L}_{national} \times F . E {.}_{national} + {L}_{highway} \times F . E {.}_{highway} ) \times r$$

wherein W is the battery energy required for the vehicle to travel to the target location, L_{city} is the length of the urban road during vehicle traveling, F.E._{city} is the unit road energy consumption of the urban road, Lₙₐₜᵢₒₙₐₗ is the length of the national road during the traveling process, F.E.ₙₐₜᵢₒₙₐₗ is the unit road energy consumption of the national road, L_{highway} is the length of the highway during the traveling process, F.E._{highway} is the unit road energy consumption of the highway, and r is a correction factor calculated according to the road gradient. In another embodiment, road information on the traveling route may further include a traveling speed and traveling time of the vehicle.

Such implementations may be based on map information planning, and map information may be used in the map information planning to plan a route from a departure point to a destination—for example, a route with the shortest time to reach the destination.

In the process of generating a route, a trajectory followed by the vehicle may be generated, and the trajectory may limit specific characteristics of the vehicle, such as acceleration and speed so that the vehicle may follow the route toward the destination.

Accordingly, in the above embodiment of the present disclosure, the map information of the big data (which includes online map road conditions and traffic information) may provide traveling speed, acceleration and traveling time for each road.

The controller 20 may estimate the speed, acceleration, and travel time of the vehicle to reach an arbitrary location at each time in the traveling route generated in step (S11) based on the provided traveling speed, acceleration, and traveling time.

In the above embodiment, the controller 20 may calculate the battery energy required for the vehicle to travel to the destination by accumulating the power that the wheels must output at each time.

That is, the following equation may be applied.

$$W = {\int }_{0}^{{t}_{city}} {P}_{city} dt + {\int }_{0}^{{t}_{national}} {P}_{national} dt + {\int }_{0}^{{t}_{highway}} {P}_{highway} dt$$

wherein W is the battery energy required for the vehicle to travel to the target location, t_{city} is the traveling time of the vehicle on a city road, tₙₐₜᵢₒₙₐₗ is the traveling time of the vehicle on a national road, t_{highway} is the traveling time of the vehicle on a highway, Pₙₐₜᵢₒₙₐₗ is the power that the wheels must output at each time when the vehicle is traveling on a national road, P_{highway} is the power that the wheels must output at each time when the vehicle is traveling on a highway, and P_{city} is the power that the wheels must output at each time when the vehicle is traveling on a city road.

Specifically, in the first embodiment, any one of P_{city}, P_{highway}, and Pₙₐₜᵢₒₙₐₗ (i.e., the power that the wheels must output at each time) may be calculated by the following equation:

$$P = [ {f}_{0} + {f}_{1} \times ( \frac{{V}_{i} + {V}_{i - 1}}{2} ) + {f}_{2} \times {( \frac{{V}_{i} + {V}_{i - 1}}{2} )}^{2} + ( 1.03 \times TM ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀, f₁, and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

Specifically, the unit of f₀ is N, the unit of f₁ is N/kph, and the unit of f₂ is N/kph².

f₀, f₁, and f₂ are fixed parameters pre-stored in the controller and have different values depending on different road types.

The units of Vᵢ and Vᵢ₋₁ are kph, and the coefficient 3.6 is used for conversion to time units.

Additionally, the coefficient of 1.03 is the coefficient after considering the vehicle rotational mass.

For the equation of the first embodiment,

$${f}_{0} + {f}_{1} \times ( \frac{{V}_{i} + {V}_{i - 1}}{2} ) + {f}_{2} \times {( \frac{{V}_{i} + {V}_{i - 1}}{2} )}^{2}$$

means the driving resistance of a vehicle on an actual road, and its value is related to the traveling speed.

Therefore, at the end of each vehicle traveling journey, the driving resistance corresponding to each vehicle speed is recalculated based on the battery energy consumed during the traveling journey, and the driving resistance value corresponding to each vehicle speed is corrected.

$$( 1.03 \times TM ) \times ( \frac{{V}_{i} - {V}_{i - 1}}{Δ t} )$$

means acceleration resistance, and TM×g×sin a means gradient resistance.

In the second embodiment, the equation of the first embodiment may be fitted, the purpose of which is to apply the influence of the road gradient to f₀.

In other words, the following equation may be used to calculate the power the wheels must output at each time:

$$P = [ {f}_{0} \times cos a + {f}_{2} \times {( \frac{{V}_{i} + {V}_{i - 1}}{2} )}^{2} + ( 1.03 \times TM ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀ and f₂ are vehicle road load coefficients, each of which has a different value depending on the road type, and the values of f₀ and f₂ may be stored in advance in the controller.

Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

In the third embodiment, the following equation may be used to calculate the power the wheels must output at each time:

$$P = [ TM \times f \times cos a + \frac{{C}_{D} \times A}{21.25} \times {( \frac{{V}_{i} + {V}_{i - 1}}{2} )}^{2} + TM \times g \times sin a + ( 1.03 \times TM ) \times ( \frac{{V}_{i} - {V}_{i - 1}}{Δ t} ) ] \times \frac{{V}_{i}}{3.6}$$

wherein P is the power that the wheels must output at time (i), f is the rolling resistance coefficient, which has different values depending on the road type, and the value of f may be stored in advance in the controller.

C_{D} is the wind resistance coefficient, A is the frontal area, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

Further, the coefficient 21.15 is the product of the time unit conversion value (3.6×3.6) and the air density value.

$$\frac{{C}_{D} \times A}{21.25} \times {( \frac{{V}_{i} + {V}_{i - 1}}{2} )}^{2}$$

means air resistance.

Therefore, even if a driver drives the vehicle to an unfamiliar location, the battery energy required for the vehicle to travel to the destination may be accurately calculated according to an embodiment of the present disclosure.

According to an embodiment of the present disclosure, the controller 20 may obtain the available battery energy (Wₐ) (S15) and determine whether the available battery energy (Wₐ) is greater than the energy (W) required for the vehicle to travel to the destination.

If the available battery energy (Wₐ) is determined to be less than or equal to the energy (W) required for the vehicle to travel to the destination, it indicates that the current amount of electricity in the vehicle may or may not be sufficient for the vehicle to travel to the destination. Therefore, even if the driver chooses not to charge the vehicle battery while driving, the vehicle must be charged.

Otherwise, the vehicle is not able to reach the destination or the HVAC system cannot be turned on during the entire journey.

If the available battery energy (Wₐ) is determined to be greater than the energy (W) required for the vehicle to travel to the destination, it indicates that there is energy remaining that can be allocated to the HVAC system.

Accordingly, the controller 20 may calculate the available battery energy (Wᵣ) of the HVAC system based on the difference value between the available battery energy (Wₐ) and the energy (W) required for the vehicle to travel to the destination (S16), and the calculated available battery energy of the HVAC system can then be used to meet the HVAC demand.

That is, the available battery energy (Wᵣ) of the HVAC system is calculated by the following equation:

$${W}_{r} = {W}_{e} - W$$

wherein W is the battery energy required for the vehicle to travel to the target location, Wₐ is the available battery energy, and Wᵣ is the available battery energy of the HVAC system.

The controller 20 may obtain the traveling time for the vehicle to reach the destination.

Afterwards, the controller 20 may calculate the maximum available power of the HVAC system by the following equation (S18).

$${P}_{HVAC} = \frac{{W}_{r}}{T}$$

Here, Wᵣ is the available battery energy of the HVAC system, P_{HVAC} is the maximum available power of the HVAC system, and T is the traveling time until the vehicle arrives at the destination.

The controller 20 controls the operation of the HVAC system according to the maximum available power (P_{HVAC}) of the HVAC system (S19).

Specifically, the controller 20 controls the operating power of the HVAC system to be maintained below the maximum available power (P_{HVAC}) of the HVAC system to secure sufficient battery energy for the vehicle to travel to the destination, and the HVAC system may be turned on while the vehicle travels to the destination.

Generally, the HVAC system in an electric vehicle has multiple operating modes.

Each operating mode has an upper limit of operating power.

In an embodiment of the present disclosure, the controller 20 compares the maximum available power (P_{HVAC}) of the HVAC system with the upper limit of the operating power of the operating mode, determines the operating mode in which the upper limit of the operating power is less than or equal to the maximum available power (P_{HVAC}) of the HVAC system as a selectable operating mode, and provides the operating mode to the driver.

In an embodiment of the present disclosure, the controller 20 may control the output device 30 to output the determined selectable operating mode.

Specifically, the output device 30 may be a display.

The display may display information related to the operation of the vehicle.

In an embodiment of the present disclosure, the controller 20 may control the display to display the determined selectable operating mode.

As described above, the input device 10 may receive driver input.

Thus, for example, the driver may select from selectable operating modes via touch input, or the driver may select any one of the selectable operating modes according to his or her usual habits.

In response to the input device 10 receiving the driver input selecting an operating mode, the controller 20 may control the HVAC system to operate in the selected operating mode.

In response to the input device 10 not receiving the driver input selecting an operating mode, the controller 20 may control the HVAC system to operate at the maximum available power (P_{HVAC}) of the HVAC system.

For example, the HVAC system may have a comfort mode, an eco mode, and an unlimited power mode.

Table 1 lists the power ranges for each operating mode of the HVAC system for cooling or heating.

Here, Pₘₐₓ is the maximum power of the HVAC system.

TABLE 1

| | Cooling | Heating |
|---|---|---|
| Comfort mode | 0-1000 W | 0-2000 W |
| Eco mode | 0-300 W | 0-800 W |
| Unlimited power mode | 0-Pₘₐₓ | 0-Pₘₐₓ |

Referring to Table 1, when cooling or heating the HVAC system, the upper limit of the operating power in unlimited power mode is the maximum power of the HVAC system, which is greater than the upper limit of the operating power in comfort mode and eco mode.

Additionally, the upper limit of the operating power in comfort mode is greater than the upper limit of the operating power in eco mode.

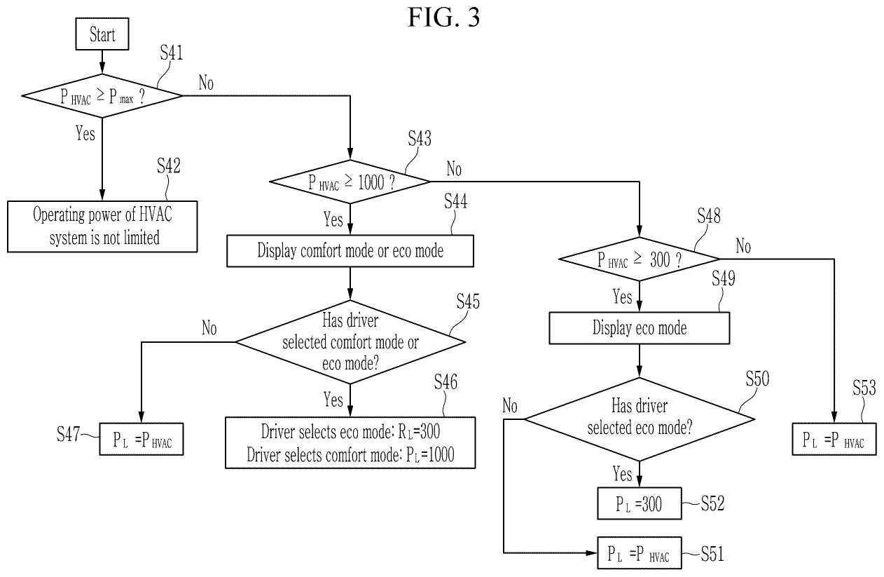

FIG. 3 is a flowchart of the operation of a controller that controls the operation of an HVAC system according to an embodiment of the present disclosure.

For example, when the HVAC system is in cooling mode, the controller 20 may determine whether the maximum available power (P_{HVAC}) of the HVAC system is greater than or equal to the upper limit (Pₘₐₓ, e.g., 3000 W) of the operating power in unlimited power mode (S41).

If the maximum available power (P_{HVAC}) of the HVAC system is greater than or equal to the upper limit (Pₘₐₓ) of the operating power in unlimited power mode (“Yes” in step (S41)), the upper limit of the operating power in unlimited power mode represents the maximum power of the HVAC system, so even if the HVAC system operates at maximum power, the condition of being less than or equal to the maximum available power (P_{HVAC}) of the HVAC system may be satisfied.

At this time, the operating power of the HVAC system is not limited (S42).

If the maximum available power (P_{HVAC}) of the HVAC system is less than the upper limit (Pₘₐₓ) of the operating power in unlimited power mode (“No” in step (S41), the controller 20 may determine whether the maximum available power (P_{HVAC}) of the HVAC system is greater than or equal to the upper limit (e.g., 1000 W) of the operating power in comfort mode (S43).

If the maximum available power (P_{HVAC}) of the HVAC system is greater than or equal to the upper limit of the operating power of comfort mode (“Yes” in step (S43)), it can be further inferred that the maximum available power (P_{HVAC}) of the HVAC system is necessarily greater than the upper limit of the operating power in eco mode.

This indicates that the operating power when the HVAC system is operating in comfort mode or eco mode may meet the condition that it is less than or equal to the maximum available power (P_{HVAC}) of the HVAC system.

At this time, comfort mode and eco mode are determined as selectable operating modes.

The controller 20 may control the display to display comfort mode and eco mode (S44), and the driver may select one of comfort mode and eco mode by touching the display.

The controller 20 may determine whether the driver has selected one of comfort mode and eco mode (S45).

When the driver has selected one of comfort mode and eco mode (“Yes” in step (S45))—for example, when the driver selects comfort mode—the controller 20 controls the HVAC system to operate in comfort mode.

At this time, the limited power (P_{L}) of the HVAC system is equal to the upper limit of the operating power in comfort mode.

When the driver selects comfort mode, the controller 20 controls the HVAC system to operate in eco mode, and at this time, the limited power (P_{L}) of the HVAC system is equal to the upper limit of the operating power of eco mode (S46).

If the driver does not select any one of comfort mode and eco mode (“No” in step (S45)), the controller 20 may control the HVAC system to operate at the maximum available power (P_{HVAC}) of the HVAC system, where the limited power (P_{L}) of the HVAC system is equal to the maximum available power (P_{HVAC}) of the HVAC system (S47).

If the maximum available power (P_{HVAC}) of the HVAC system is less than the upper limit of the operating power in comfort mode (“No” in step (S43)), the controller 20 may determine whether the maximum available power (P_{HVAC}) of the HVAC system is greater than or equal to the upper limit (e.g., 300 W) of the operating power in eco mode (S48).

If the maximum available power (P_{HVAC}) of the HVAC system is greater than or equal to the upper limit of the operating power of eco mode (“Yes” in step (S48)), it indicates that the operating power when the HVAC system operates in eco mode may be less than or equal to the maximum available power (P_{HVAC}) of the HVAC system.

At this time, eco mode is determined as the selectable operating mode.

Similarly, the controller 20 may control the display to display “eco mode” (S49), and the driver may select “eco mode” by touching the display.

The controller 20 may determine whether the driver has selected “eco mode” (S50).

When the driver has selected “eco mode” (“Yes” in step (S50)), the controller 20 controls the HVAC system to operate in eco mode, and at this time, the limited power (P_{L}) of the HVAC system is equal to the upper limit of the operating power in eco mode (S52).

If the driver does not select “eco mode” (“No” in step (S50)), the controller 20 may control the HVAC system to operate at the maximum available power (P_{HVAC}) of the HVAC system, and at this time, the limited power (P_{L}) of the HVAC system is equal to the maximum available power (P_{HVAC}) of the HVAC system (S51).

However, if the maximum available power (P_{HVAC}) of the HVAC system is less than the upper limit of the operating power in eco mode (“No” in step (S48), the controller 20 controls the HVAC system to operate at the maximum available power (P_{HVAC}) of the HVAC system, and at this time, the limited power (P_{L}) of the HVAC system is equal to the maximum available power (P_{HVAC}) of the HVAC system (S53).

As described above, the limited power (P_{L}) of the HVAC system may be the maximum available power (P_{HVAC}) of the HVAC system or may be the upper limit in the operating mode selected by the driver (e.g., comfort mode, eco mode, or unlimited power mode).

This enables the controller 20 to calculate the available time of the HVAC system by the following equation:

$${T}_{a} = \frac{{W}_{r}}{{P}_{L}}$$

Here, Wᵣ is the available battery energy of the HVAC system, Tₐ is the available time of the HVAC system, and P_{L} is the limited power of the HVAC system.

Additionally, during vehicle traveling, the available time (Tₐ) of the HVAC system may vary depending on the driver's re-operation of the HVAC system.

As described above, the controller 20 may control the output device 30 to output information related to the allocation of battery energy.

For example, the controller 20 may control the display to display the battery energy (W) required for the vehicle to travel to the destination, the available battery energy (Wᵣ) of the HVAC system, the available time (Tₐ) of the HVAC system, and the distance till empty (DTE).

Here, the DTE may be calculated by the following equation:

$$DTE = ( {W}_{a}^{′} - {W}_{r}^{′} ) \times \frac{{L}_{t otal}}{W}$$

wherein Wₐ′ is the available battery energy after the vehicle has travelled for a specific period of time, Wᵣ′ is the available energy of the HVAC system after the specific period of time, which may be the difference between the available battery energy of the HVAC system (Wᵣ) and the used battery energy of the HVAC system within the specific period of time (which may be calculated by accumulating the actual operating power of the HVAC system within the specific period of time), Lₜₒₜₐₗ is the traveling distance to the target location (in this case, the destination), and W is the battery energy required for the vehicle to travel to the destination.

The DTE calculated according to the above equation is more accurate, and the driver may know the DTE in real time during the journey.

Returning to FIG. 2, when the input device 10 receives the driver input to charge the vehicle battery during vehicle traveling, this means that the driver has the intention of charging the vehicle during this journey (S20).

Therefore, the controller 20 may first operate the HVAC system so that the driver may obtain a comfortable driving experience.

There is no priority distinction between the vehicle traveling demand and the HVAC demand.

Battery energy may be allocated synchronously to vehicle traveling demand and the HVAC demand, but it must be ensured that the vehicle may reach the charging station before the battery energy is depleted.

According to an embodiment of the present disclosure, the input device 10 is further configured to receive driver input for setting the operating power (Pₛ) of the HVAC system.

In other words, the driver first presets the vehicle's HVAC system after getting in (S21).

For example, the driver may set the operating mode of the HVAC system to comfort mode as shown in Table 1, and further, the driver may set the target temperature and/or the number of blower stages.

At this time, the maximum and minimum operating power of the HVAC system are limited.

As described above, the controller 20 may obtain road information on the traveling route based on the generated traveling route (S22).

As described above, the road information may include the traveling speed, traveling time, and road gradient of the vehicle.

The controller 20 calculates the power that the wheels must output at each time based on road information on the traveling route by the following equation (S23):

$$P = [ {f}_{0} + {f}_{1} \times ( \frac{{V}_{i} + {V}_{i - 1}}{2} ) + {f}_{2} \times {( \frac{{V}_{i} + {V}_{i - 1}}{2} )}^{2} + ( 1.03 \times T M ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀, f₁, and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

In other embodiments, the two different equations described above may be used to calculate the power (P) that the wheels must output at each time.

Since battery energy is synchronously allocated to the vehicle traveling demand and the HVAC demand, the total power that the vehicle must output may be calculated as follows (S24).

$${P}_{t otal} = {P}_{s} + P$$

Here, Pₜₒₜₐₗ is the total power that the vehicle must output, Pₛ is the operating power of the HVAC system set by the driver, and P is the power that the wheels must output at each time.

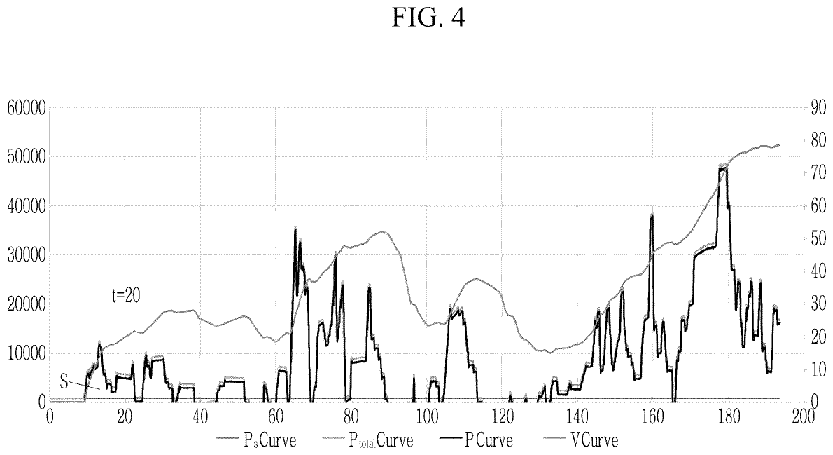

FIG. 4 schematically illustrates curves showing changes over time in the vehicle's traveling speed V, the operating power of the HVAC system Pₛ set by the driver, the power that the wheels must output at each time P, and the total power that the vehicle must output Pₜₒₜₐₗ, and below, these curves are abbreviated as V curve, Pₛ curve, P curve, and Pₜₒₜₐₗ curve, respectively.

As shown in FIG. 4, the Pₛ curve is a straight line, which means that the operating power (Pₛ) of the HVAC system is a constant value in the driver's settings.

Since Pₛ is constant and Pₜₒₜₐₗ=Pₛ+P, the Pₜₒₜₐₗ curve is located above the P curve, the change trends of the P curve and the Pₜₒₜₐₗ curve are the same and correspond to the same time, and the difference value between a vertical coordinate value of the Pₜₒₜₐₗ curve and a vertical coordinate value of the P curve is Pₛ.

After calculating the total power (Pₜₒₜₐₗ) that the vehicle must output, the total power (Pₜₒₜₐₗ) that the vehicle must output may be accumulated to calculate the accumulated battery energy required for the vehicle (S25).

The accumulated battery energy required for the vehicle may be calculated as the sum of the driving demand and the HVAC demand.

$${W}_{total} = {\int }_{0}^{t} {P}_{t otal} dt$$

Here, Wₜₒₜₐₗ is the accumulated battery energy required for the vehicle.

As shown in FIG. 4, for example, if the time t is 20, the accumulated battery energy (Wₜₒₜₐₗ) required for the vehicle is represented by an area S of the region consisting of the Pₜₒₜₐₗ curve, the horizontal axis among the coordinate axes, and the straight line (t=20).

In other words, the accumulated battery energy (Wₜₒₜₐₗ) required for the vehicle corresponds to time, and accordingly, a curve (hereinafter abbreviated as a Wₜₒₜₐₗ curve) in which the accumulated battery energy (Wₜₒₜₐₗ) required for the vehicle changes over time may be obtained.

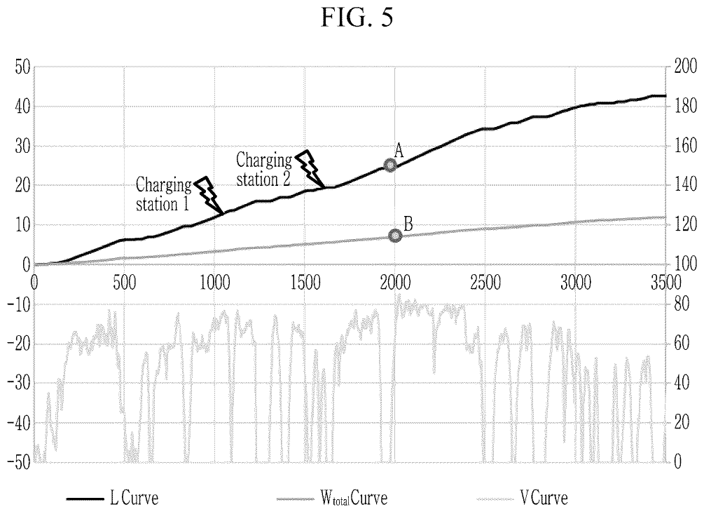

FIG. 5 schematically illustrates the Wₜₒₜₐₗ curve.

In addition, as described above, the controller 20 may obtain the traveling speed at each time on the traveling route, and FIG. 5 schematically illustrates a curve (i.e., V curve) in which the traveling speed V of the vehicle changes over time.

Additionally, by accumulating the traveling speed, the controller 20 may obtain the traveling distance of the vehicle corresponding to time—for example, FIG. 5 schematically illustrates a curve (hereinafter abbreviated as L curve) in which the traveling distance of the vehicle changes over time.

Additionally, the controller 20 may obtain the available battery energy (Wₐ) (S26).

The controller 20 compares the accumulated battery energy (Wₜₒₜₐₗ) required for the vehicle with the available battery energy (Wₐ), and then determines the time at which the accumulated battery energy (Wₜₒₜₐₗ) required for the vehicle is equal to the available battery energy (Wₐ), and may determine the traveling distance of the vehicle corresponding to the determined time as the maximum traveling distance (Lₐ) (S27).

In other words, at the maximum traveling distance (Lₐ), the vehicle cannot travel and the HVAC system cannot operate because the available battery energy is completely consumed.

Specifically, as shown in FIG. 5, the controller 20 may determine a point (point B in FIG. 5) on the Wₐ curve in which a vertical coordinate value is the available battery energy (Wₐ) based on the Wₜₒₜₐₗ curve.

Based on a horizontal coordinate value that is the same as point B, if point A is determined on the L curve, the vertical coordinate value of point A is the maximum traveling distance (Lₐ).

The controller 20 may obtain a charging station on the traveling route based on the generated traveling route and obtain the traveling distance to the charging station (S28).

In this case, the controller 20 may be implemented as part of the AVNT system.

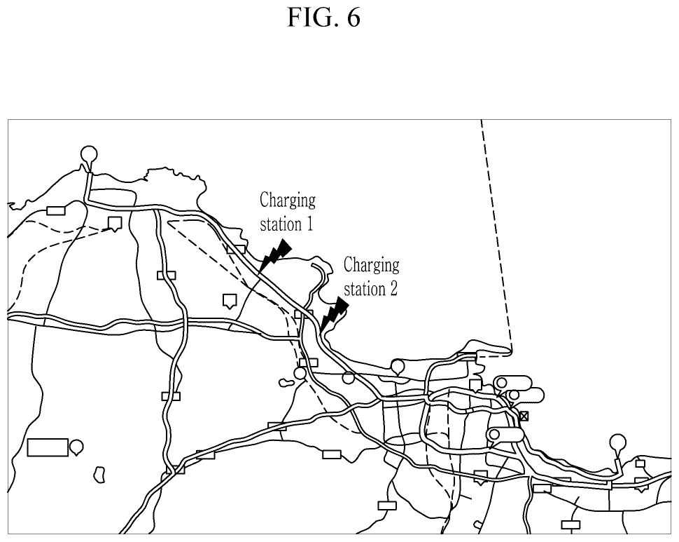

FIG. 6 schematically illustrates the generated traveling route and charging stations located on the traveling route.

The controller 20 may obtain charging station 1 and charging station 2, the traveling distance to charging station 1 is L₁, the traveling distance to charging station 2 is L₂, and L₁<L₂.

The controller 20 may compare the traveling distance to the charging station and the maximum traveling distance (Lₐ).

If the traveling distance to the charging station is less than or equal to the maximum traveling distance (Lₐ), the corresponding charging station may be determined as the charging station that the vehicle may reach.

For example, as shown in FIG. 5, if the traveling distance to charging station 1 (L₁) and the traveling distance to charging station 2 (L₂) are both less than the maximum traveling distance (Lₐ), then charging station 1 and charging station 2 are both determined as charging stations that the vehicle may reach.

The controller 20 may control the display to display charging station 1 and charging station 2.

For example, in FIG. 5 and FIG. 6, charging stations 1 and 2 are highlighted.

However, if the traveling distance to charging station 1 (L₁) is less than the maximum traveling distance (Lₐ) and the traveling distance to charging station 2 (L₂) is greater than the maximum traveling distance (Lₐ), the controller 20 may determine charging station 1 as a charging station that the vehicle may reach.

The controller 20 may control the display to indicate a charging station that the vehicle may reach.

In the above two situations, if there is a charging station that the vehicle may reach, the controller 20 may determine that the vehicle traveling demand may be satisfied (S29).

In other words, the vehicle may travel to a charging station and then be charged.

At this time, the HVAC system may operate at the operating power (Pₛ) set by the driver (S30).

However, if all traveling distances to the charging station are greater than the maximum traveling distance (Lₐ), it means that there is no charging station that the vehicle may reach (S31), and the controller 20 determines that the vehicle traveling demand cannot be satisfied.

At this time, the HVAC system cannot operate at the operating power (Pₛ) set by the driver, and the operating power of the HVAC system must be limited.

At this time, the priority of the vehicle traveling demand should be higher than the priority of the HVAC demand, and the battery energy should be preferentially allocated to the vehicle driving so that the vehicle may reach the charging station, and then the remaining battery energy may be allocated to the HVAC system.

In this case, the controller 20 may set the charging station with the closest distance on the traveling route (i.e., charging station 1) as the target location.

In other embodiments, the controller 20 may re-determine the charging station and determine the re-determined charging station as the target location.

Specifically, the controller 20 may search for charging stations around the vehicle departure point (i.e., charging stations other than charging station 1 and charging station 2) and generate a new traveling route based on the surrounding charging stations.

After determining a charging station as the target location (S32), the controller 20 performs steps (S33) to (S37).

Steps (S33) to (S37) are similar to steps (S14) to (S19), but there is a difference in that the driving demand in steps (S14) to (S19) is the battery energy required for the vehicle to travel to the destination, and the driving demand in steps (S31) to (S36) is the battery energy required for the vehicle to travel to the charging station.

Specifically, the controller 20 calculates the battery energy (W) required for the vehicle to travel to the charging station based on road information on the traveling route (S33).

The controller 20 may calculate the available battery energy (Wᵣ) of the HVAC system based on the difference value between the available battery energy (W) and the battery energy (Wₐ) required for the vehicle to travel to the charging station (S34).

If the charging station is the re-determined charging station, the controller 20 obtains the traveling time (T) to the charging station (S35).

The controller 20 may calculate the maximum available power (P_{HVAC}) of the HVAC system based on the ratio of the available battery energy (Wᵣ) of the HVAC system and the traveling time (T) to the charging station (S36), and may control the HVAC system based on the maximum available power (P_{HVAC}) of the HVAC system (S37).

The controller 20 may calculate the available time (Tₐ) of the HVAC system based on the ratio of the available battery energy (Wᵣ) of the HVAC system and the operating power (Pₛ) of the HVAC system set by the driver.

The controller 20 may control the display to display the battery energy (W) required for the vehicle to travel to the charging station, the available battery energy (Wᵣ) of the HVAC system, the available time (Tₐ) of the HVAC system, and the DTE.

In the description, unless it is specifically stated that the controller 20 is implemented as part of the AVNT system, the controller 20 is otherwise implemented as a vehicle controller unit (VCU).

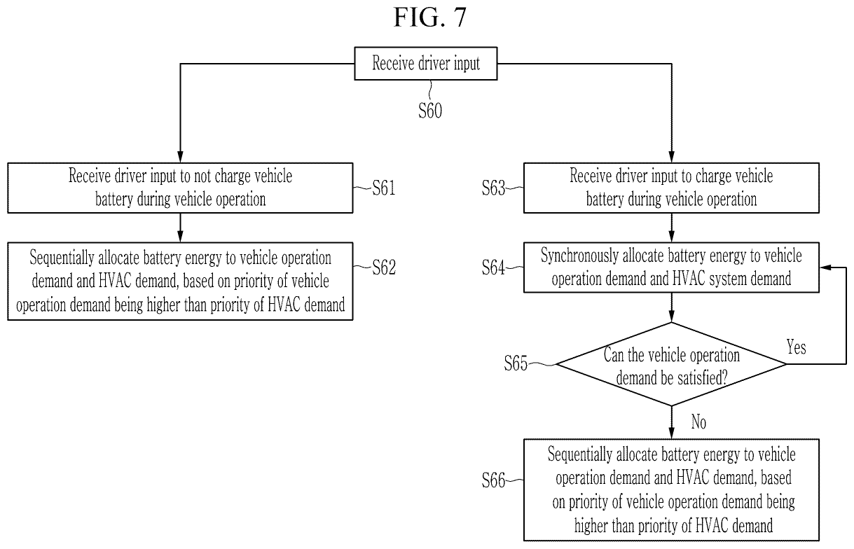

FIG. 7 is a flowchart of a battery energy allocation method according to an embodiment of the present disclosure.

As shown in FIG. 7, a battery energy allocation method for an electric vehicle includes a step (S60) of receiving driver input, including at least driver input to charge a vehicle battery during vehicle traveling and driver input indicating no charging during travel, a step (S62) of sequentially allocating battery energy to a vehicle traveling demand and an HVAC demand, based on the priority of the vehicle traveling demand being higher than the priority of the HVAC demand, in response to receiving the driver input indicating no charging during travel (S61), and a step (S64) of synchronously allocating battery energy to the vehicle traveling demand and the HVAC demand in response to receiving the driver input to charge the vehicle battery during vehicle traveling (S63).

The battery energy allocation method may further include a step (S65) of determining whether the vehicle traveling demand may be satisfied when synchronously allocating battery energy to the vehicle traveling demand and the HVAC demand, and a step (S66) of sequentially allocating battery energy to the vehicle traveling demand and the HVAC demand according to the priority of the vehicle traveling demand being higher than the priority of the HVAC demand, based on a determination that the vehicle traveling demand cannot be satisfied (“No” in step (S65)).

If it is determined that the vehicle traveling demand may be satisfied (“Yes” in step (S65)), battery energy is synchronously allocated to the vehicle traveling demand and the HVAC demand as originally intended (S64).

The driver input includes driver input regarding vehicle traveling route setting.

The steps (S62, S64, and S66) of allocating battery energy to the vehicle driving demand include a step of generating a traveling route based on the driver input regarding vehicle traveling path setting received by the input device, and a step of obtaining road information on the traveling route based on the generated traveling route.

The road information on the traveling route includes at least some of the following: road types included in the traveling route, the length of each road type, the unit road energy consumption corresponding to each road type, the traveling speed, traveling time, and road gradient of the vehicle.

According to an embodiment of the present disclosure, the road information on the traveling route includes the road types included in the traveling route, the length of each road type, the unit road energy consumption corresponding to each road type.

The steps of sequentially allocating battery energy to the vehicle traveling demand and the HVAC demand (S62 and S66) include a step of calculating battery energy required for the vehicle to travel to a target location by the following equation based on obtained road information on the traveling route:

$$W = ( {L}_{c i t y} \times F . E {.}_{c i t y} + {L}_{n a t i onal} \times F . E {.}_{n a t i onal} + {L}_{h i g h w a y} \times F . E {.}_{h i g h w a y} ) \times r$$

wherein W is the battery energy required for the vehicle to travel to the target location, L_{city} is the length of the urban road during vehicle traveling, F.E._{city} is the unit road energy consumption of the urban road, Lₙₐₜᵢₒₙₐₗ is the length of a national road during the traveling process, F.E.ₙₐₜᵢₒₙₐₗ is the unit road energy consumption of a national road, L_{highway} is the length of a highway during the traveling process, F.E._{highway} is the unit road energy consumption of the highway, and r is a correction factor calculated according to the road gradient during the traveling process.

According to another embodiment of the present disclosure, the road information on the traveling route includes road types included in the traveling route, the traveling speed, traveling time, and road gradient of the vehicle.

The steps of sequentially allocating battery energy to the vehicle traveling demand and the HVAC demand (S62 and S66) include a step of calculating battery energy required for the vehicle to travel to a target location by the following equation based on obtained road information on the traveling route:

$$W = {\int }_{0}^{{t}_{c i t y}} {P}_{c i t y} dt + {\int }_{0}^{{t}_{n a t i onal}} {P}_{n a tional} dt + {\int }_{0}^{{t}_{highway}} {P}_{h i g h w a y} d t$$

wherein W is the battery energy required for the vehicle to travel to the target location, t_{city} is the traveling time of the vehicle on a city road, tₙₐₜᵢₒₙₐₗ is the traveling time of the vehicle on a national road, t_{highway} is the traveling time of the vehicle on a highway, Pₙₐₜᵢₒₙₐₗ is the power that the wheels must output at each time when the vehicle is traveling on a national road, P_{highway} is the power that the wheels must output at each time when the vehicle is traveling on a highway, and P_{city} is the power that the wheels must output at each time when the vehicle is traveling on a city road.

The target location is set as the destination based on receiving the driver input indicating no charging during travel.

That is, in step (S62), the target location is set as the destination.

The target location is set as the charging station based on receiving the driver input indicating no charging during travel.

That is, in step (S66), the target location is set as the charging station.

Any one of P_{city}, P_{highway}, and Pₙₐₜᵢₒₙₐₗ (i.e., the power that the wheels must output at each time) may be calculated by the following equation:

$$P = [ {f}_{0} + {f}_{1} \times ( \frac{{V}_{i} + {V}_{i - 1}}{2} ) + {f}_{2} \times {( \frac{{V}_{i} + {V}_{i - 1}}{2} )}^{2} + ( 1.03 \times T M ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀, f₁, and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

Alternatively, the following equation may be used to calculate the power the wheels must output at each time:

$$P = [ {f}_{0} \times cos a + {f}_{2} \times {( \frac{{V}_{i} + {V}_{i - 1}}{2} )}^{2} + ( 1.03 \times T M ) \times ( \frac{{V}_{i} - {V}_{i - 1}}{Δ t} ) + TM \times g \times sin a ] \times \frac{{V}_{i}}{3.6}$$

wherein P is the power that the wheels must output at time (i), f₀ and f₂ are vehicle road load coefficients, each of which has a different value depending on the road type, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

Alternatively, the following equation may be used to calculate the power the wheels must output at each time:

$$P = [ T M \times f \times cos a + \frac{{C}_{D} \times A}{21.25} \times {( \frac{{V}_{i} + {V}_{i - 1}}{2} )}^{2} + TM \times g \times sin + ( 1.03 \times T M ) \times ( \frac{{V}_{i} - {V}_{i - 1}}{Δ t} ) ] \times \frac{{V}_{i}}{3.6}$$

wherein P is the power that the wheels must output at time (i), f is the rolling resistance coefficient, which has different values depending on the road type, C_{D} is the wind resistance coefficient, A is the frontal area, Vᵢ is the traveling speed of the vehicle at time (i), Vᵢ₋₁ is the traveling speed of the vehicle at time (i−1), Δt is the time difference between time (i) and time (i−1), TM is the vehicle's mass, g is the acceleration of gravity, and a is the road gradient.

The steps of sequentially allocating battery energy to the vehicle traveling demand and the HVAC demand (S62 and S66) include a step of calculating available battery energy of the HVAC system by the following equation based on the battery energy (W, i.e., driving demand) required for the vehicle to travel to the calculated target location, and setting the calculated available battery energy of the HVAC system as the HVAC demand:

$${W}_{r} = {W}_{a} - W$$

Here, W is the battery energy required for the vehicle to travel to the target location, Wᵣ is the available battery energy of the HVAC system, and Wₐ is the available battery energy.

According to an embodiment of the present disclosure, the battery energy allocation method for the electric vehicle further includes a step of controlling of the operation of the HVAC system based on the available battery energy (Wᵣ) of the calculated HVAC system.

Specifically, the step of controlling of the operation of the HVAC system based on the available battery energy (Wᵣ) of the calculated HVAC system includes the step of calculating the maximum available power (P_{HVAC}) of the HVAC system.

$${P}_{H V A C} = \frac{{W}_{r}}{T}$$

Here, P_{HVAC} is the maximum available power of the HVAC system, and T is the traveling time for the vehicle to reach the target location.

After calculating the maximum available power (P_{HVAC}) of the HVAC system, the operating power of the HVAC system is controlled to be maintained at a state less than or equal to the maximum available power (P_{HVAC}) of the HVAC system.

Specifically, the step of controlling the operating power of the HVAC system to be maintained at a state less than or equal to the maximum available power (P_{HVAC}) of the HVAC system includes a step of comparing the maximum available power (P_{HVAC}) of the HVAC system with the upper limit of the operating power of the operating mode of the HVAC system, a step of determining an operating mode in which the upper limit of the operating power is less than or equal to the maximum available power (P_{HVAC}) of the HVAC system as a selectable operating mode, and a step of providing the determined operating mode to the driver.

The driver input includes driver input for setting the operating power of the HVAC system.

Step (S64) of synchronously allocating battery energy to the vehicle traveling demand and the HVAC demand includes a step of calculating the accumulated battery energy required for the vehicle by the following equation based on obtained road information on the traveling route, and setting the accumulated battery energy required for the vehicle as the sum of the vehicle traveling demand and the HVAC demand:

$${W}_{t otal} = {\int }_{0}^{t} ( {P}_{s} + P ) d t$$

wherein Wₜₒₜₐₗ is the accumulated battery energy required for the vehicle, Pₛ is the operating power of the HVAC system set by the driver, and P is the power that the wheels must output at each time; three calculation equations are provided above.

Step (S65) of determining whether the vehicle traveling demand may be satisfied includes a step of obtaining the traveling speed of the vehicle and accumulating the traveling speed (V) of the vehicle to obtain the traveling distance (L) of the vehicle corresponding to the time, a step of comparing the accumulated battery energy (Wₜₒₜₐₗ) required for the vehicle with the available battery energy (Wₐ), a step of determining the time when the accumulated battery energy (Wₜₒₜₐₗ) required for the vehicle is equal to the available battery energy (Wₐ), and a step of determining the traveling distance (L) of the vehicle corresponding to the determined time as the maximum traveling distance (Lₐ).

After a charging station along the traveling route according to the generated traveling route and the traveling distance to the charging station are obtained, the traveling distance (L₁, L₂ . . . ) to the charging station is compared with the maximum traveling distance (Lₐ), based on whether the traveling distance (e.g., L₁ and L₂) to the charging station is less than or equal to the maximum traveling distance (Lₐ), the corresponding charging stations (corresponding to L₁ and L₂, respectively) are determined as charging stations that the vehicle may reach, it is determined that the vehicle traveling demand may be satisfied based on the existence of the charging station that the vehicle may reach, and conversely, it is determined that the vehicle driving demand may not be satisfied based on the absence of any charging station that the vehicle may reach.

The steps of sequentially allocating battery energy to the vehicle traveling demand and the HVAC demand (S62 and S66) may further include a step of outputting the battery energy (W) required for the vehicle to travel to the target location, the available battery energy (Wᵣ) of the HVAC system, the available time (Tₐ) of the HVAC system, and the DTE (Lᵣ), and the available time (Tₐ) of the HVAC system and the DTE (Lᵣ) are calculated by the following equation:

$${T}_{a} = \frac{{W}_{r}}{{P}_{L}}$$

Here, Tₐ is the available time of the HVAC system, Wᵣ is the available battery energy of the HVAC system, P_{L} is the limited power of the HVAC system, which is the maximum available power of the HVAC system or the upper limit of the operating power in the selected operating mode.

$$DTE = ( {W}_{a}^{′} - {W}_{r}^{′} ) \times \frac{{L}_{t otal}}{W}$$

wherein DTE is the distance till empty, Wₐ′ is the available battery energy after the vehicle has traveled for a specific period of time, Wᵣ′ is the available energy of the HVAC system after the specific period of time, which is the difference between the available battery energy (Wᵣ) of the HVAC system and the used battery energy of the HVAC system within the specific period of time, Lₜₒₜₐₗ is the traveling distance to the target location, and W is the battery energy required for the vehicle to travel to the target location.

In step (S62), the target location is set as the destination, and in step (S66), the target location is set as a charging station.

According to embodiments of the present disclosure, by rationally allocating battery energy, it is possible to secure sufficient energy required for vehicle traveling, maximizing the HVAC system, thereby improving the driver's driving experience.

In addition, it is possible to accurately calculate the battery energy required for driving and at the same time accurately predict the calculated DTE.

Further, by displaying information to the driver such as battery energy required for the vehicle to travel to the target location (i.e., destination or charging station), the available battery energy of the HVAC system, the available time of the HVAC system, and the DTE, the driver's concern about lack of battery energy while driving may be reduced.

The various embodiments of the present disclosure do not enumerate all possible combinations, but rather describe representative aspects of the present disclosure, and furthermore, the contents described in the various embodiments may be applied independently or in a combination of two or more.

While the embodiments of the present disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A battery energy allocation system for an electric vehicle, comprising:
an input device receiving driver input, including at least driver input to charge a vehicle battery during vehicle traveling and driver input not to charge the vehicle battery during the vehicle traveling; and
a controller configured to:
sequentially allocate battery energy to a vehicle traveling demand and a heating, ventilation and air conditioning (HVAC) demand, based on priority of the vehicle traveling demand being higher than priority of the HVAC demand, in response to the input device receiving the driver input not to charge the vehicle battery during the vehicle traveling, and
synchronously allocate the battery energy to the vehicle traveling demand and the HVAC demand in response to the input device receiving the driver input to charge the vehicle battery during the vehicle traveling.

2. The battery energy allocation system of claim 1, wherein the controller is further configured to:
determine whether the vehicle traveling demand is satisfied based on synchronously allocating the battery energy to the vehicle traveling demand and the HVAC demand; and
sequentially allocate the battery energy to the vehicle traveling demand and the HVAC demand according to the priority of the vehicle traveling demand being higher than the priority of the HVAC demand, based on determining that the vehicle traveling demand is not satisfied.

3. The battery energy allocation system of claim 2, wherein the driver input comprises driver input regarding vehicle traveling route setting, and
the controller is configured to:
generate a traveling route based on the driver input regarding the vehicle traveling route setting received by the input device when allocating the battery energy to the vehicle traveling demand; and
obtain road information on the traveling route, including at least a portion of a road type included in the traveling route, a length of each road type, a unit road energy consumption corresponding to each road type, traveling speed and traveling time of the vehicle, and a road gradient based on the generated traveling route.

4. The battery energy allocation system of claim 3, wherein the controller is configured to:
calculate the battery energy required for the vehicle to travel to a target location based on the obtained road information on the traveling route;
set the calculated battery energy required for the vehicle to travel to the target location as the vehicle traveling demand when sequentially allocating the battery energy to the vehicle traveling demand and the HVAC demand;
set a destination as the target location based on the input device receiving the driver input not to charge the vehicle battery during the vehicle traveling; and
set a charging station as the target location based on the input device receiving the driver input to charge the vehicle battery during the vehicle traveling.

5. The battery energy allocation system of claim 4, wherein the controller is configured to:
calculate available battery energy of an HVAC system; and
set the calculated available battery energy of the HVAC system as the HVAC demand when sequentially allocating the battery energy to the vehicle traveling demand and the HVAC demand.

6. The battery energy allocation system of claim 5, wherein the controller is further configured to control operation of the HVAC system according to the calculated available battery energy of the HVAC system, and
wherein, when controlling the operation of the HVAC system based on the calculated available battery energy of the HVAC system, the controller is configured to:
calculate maximum available power of the HVAC system; and
control operating power of the HVAC system to be less than or equal to the maximum available power of the HVAC system.

7. The battery energy allocation system of claim 6, wherein the controller is configured to:
compare the maximum available power of the HVAC system with an upper limit of the operating power of an operating mode of the HVAC system when controlling the operating power of the HVAC system to be less than or equal to the maximum available power of the HVAC system; and
determine an operating mode in which the upper limit of the operating power is less than or equal to the maximum available power of the HVAC system as a selectable operating mode and provide the operating mode to a driver.

8. The battery energy allocation system of claim 3, wherein the driver input comprises driver input for setting operating power of the HVAC system,
wherein, when synchronously allocating battery energy to the vehicle traveling demand and the HVAC demand, an accumulated battery energy required for the vehicle is calculated based on the obtained road information on the traveling route, and the accumulated battery energy required for the vehicle is set as a sum of the vehicle traveling demand and the HVAC demand;
when determining whether the vehicle traveling demand is satisfied, the traveling speed of the vehicle is obtained, and the traveling speed of the vehicle is accumulated to obtain the traveling distance of the vehicle corresponding to a time;
the accumulated battery energy required for the vehicle is compared with the available battery energy;
the time when the accumulated battery energy required for the vehicle is equal to the available battery energy is determined, and the traveling distance of the vehicle corresponding to the determined time is determined as a maximum traveling distance;
a charging station along the traveling route and the traveling distance to the charging station are obtained;
the traveling distance to the charging station is compared with the maximum traveling distance;
based on the traveling distance to the charging station being less than or equal to the maximum traveling distance, the corresponding charging station is determined as a charging station that the vehicle is reachable; and
it is determined that the vehicle traveling demand is satisfied based on an existence of the charging station that the vehicle is reachable, and it is determined that the vehicle driving demand is not satisfied based on an absence of the charging station that the vehicle is reachable.

9. The battery energy allocation system of claim 7, further comprising an output device,
wherein the controller is configured to:
control the output device to output at least one of the battery energy required for the vehicle to travel to the target location, the available battery energy of the HVAC system, available time of the HVAC system, and distance till empty (DTE).

10. A battery energy allocation method for an electric vehicle, comprising:
receiving driver input, including at least driver input to charge a vehicle battery during vehicle traveling and driver input not to charge the vehicle battery during the vehicle traveling;
sequentially allocating battery energy to a vehicle traveling demand and an HVAC demand, based on priority of the vehicle traveling demand being higher than priority of the HVAC demand, in response to receiving the driver input not to charge the vehicle battery during the vehicle traveling; and
synchronously allocating the battery energy to the vehicle traveling demand and the HVAC demand in response to receiving the driver input to charge the vehicle battery during the vehicle traveling.

11. The battery energy allocation method of claim 10, wherein the synchronously allocating the battery energy to the vehicle traveling demand and the HVAC demand further comprises:
determining whether the vehicle traveling demand is satisfied; and
sequentially allocating the battery energy to the vehicle traveling demand and the HVAC demand according to the priority of the vehicle traveling demand being higher than the priority of the HVAC demand, based on determining that the vehicle traveling demand is not satisfied.

12. The battery energy allocation method of claim 11, wherein the driver input comprises driver input regarding vehicle traveling route setting, and
wherein the allocating the battery energy to the vehicle traveling demand comprises:
generating a traveling route based on the driver input regarding the vehicle traveling route setting; and
obtaining road information on the traveling route, including at least a portion of a road types included in the traveling route, a length of each road type, a unit road energy consumption corresponding to each road type, traveling speed and traveling time of the vehicle, and a road gradient based on the generated traveling route.

13. The battery energy allocation method for the electric vehicle of claim 12, wherein the sequentially allocating the battery energy to the vehicle traveling demand and the HVAC demand comprises:
calculating the battery energy required for the vehicle to travel to a target location based on the obtained road information on the traveling route;
setting the calculated battery energy required for the vehicle to travel to the target location as the vehicle traveling demand;
setting a destination as the target location based on the input device receiving the driver input not to charge the vehicle battery during the vehicle traveling; and
setting a charging station as the target location based on an input device receiving the driver input to charge the vehicle battery during the vehicle traveling.

14. The battery energy allocation method of claim 13, wherein the sequentially allocating the battery energy to the vehicle traveling demand and the HVAC demand comprises:
calculating available battery energy of an HVAC system; and
setting the calculated available battery energy of the HVAC system as the HVAC demand.

15. The battery energy allocation method of claim 14, further comprising controlling operation of the HVAC system based on the calculated available battery energy of the HVAC system,
wherein the controlling operation of the HVAC system based on the calculated available battery energy of the HVAC system comprises:
calculating maximum available power of the HVAC system; and
controlling operating power of the HVAC system to be less than or equal to the maximum available power of the HVAC system.

16. The battery energy allocation method of claim 15, wherein the controlling the operating power of the HVAC system to be less than or equal to the maximum available power of the HVAC system comprises:
comparing the maximum available power of the HVAC system with an upper limit of the operating power of an operating mode of the HVAC system;
determining an operating mode in which the upper limit of the operating power is less than or equal to the maximum available power of the HVAC system as a selectable operating mode; and
providing the determined operating mode to a driver.

17. The battery energy allocation method of claim 12, wherein the driver input comprises driver input for setting operating power of the HVAC system,
wherein the synchronously allocating the battery energy to the vehicle traveling demand and the HVAC demand further comprises:
calculating an accumulated battery energy required for the vehicle based on the obtained road information on the traveling route; and
setting the accumulated battery energy required for the vehicle as a sum of the vehicle traveling demand and the HVAC demand, and
wherein the determining whether the vehicle traveling demand is satisfied comprises:
accumulating the traveling speed of the vehicle to obtain the traveling distance of the vehicle corresponding to a time;
comparing the accumulated battery energy required for the vehicle with the available battery energy;
determining the time when the accumulated battery energy required for the vehicle is equal to the available battery energy;
determining the traveling distance of the vehicle corresponding to the determined time as a maximum traveling distance;
obtaining a charging station along the traveling route to obtain the traveling distance to the charging station;
comparing the traveling distance to the charging station with the maximum traveling distance;
determining the corresponding charging station as a charging station that the vehicle is reachable, based on the traveling distance to the charging station being less than or equal to the maximum traveling distance;
determining that the vehicle traveling demand is satisfied based on an existence of the charging station that the vehicle is reachable; and
determining that the vehicle traveling demand is not satisfied based on an absence of the charging station that the vehicle is reachable.

18. The battery energy allocation method of claim 16, wherein the sequentially allocating the battery energy to the vehicle traveling demand and the HVAC demand further comprises:
outputting at least one of the battery energy required for the vehicle to travel to the target location, the available battery energy of the HVAC system, available time of the HVAC system, and distance till empty (DTE).
